(19) United States
(12) Patent Application Publication
(10) Pub. No.: US 2024/0095494 A1
(43) Pub. Date: Mar. 21, 2024

(54) INFORMATION PROCESSING APPARATUS, DETERMINATION METHOD, AND STORAGE MEDIUM

(71) Applicant: NEC Corporation, Tokyo (JP)

(72) Inventors: Shigeaki NAMIKI, Tokyo (JP); Toshinori HOSOI, Tokyo (JP)

(73) Assignee: NEC Corporation, Tokyo (JP)

(21) Appl. No.: 18/207,459

(22) Filed: Jun. 8, 2023

(30) Foreign Application Priority Data
Sep. 16, 2022 (JP) 2022-148225

(51) Int. Cl. G06N 3/042

(52) U.S. Cl. CPC G06N 3/042

(57) ABSTRACT

In order to ensure necessary inference accuracy while minimizing inference time, an information processing apparatus (1) includes: a first difficulty calculation unit (11) that calculates difficulty in inference carried out by inputting input data, constituting a time series, to a first-stage inference model among multiple-stage inference models which are configured such that use of a later-stage inference model achieves higher inference accuracy; and a first determination unit (12) that determines, on the basis of the difficulty, whether a second- or later-stage inference model will be used.

This Nonprovisional application claims priority under 35 U.S.C. § 119 on Patent Application No. 2022-148225 filed in Japan on Sep. 16, 2022, the entire contents of which are hereby incorporated by reference.

### TECHNICAL FIELD

The present invention relates to, for example, an information processing apparatus that carries out a process related to inference with use of an inference model.

### BACKGROUND ART

Practical use of a machine-learned inference model has recently been rapidly developed in various fields. For example, in automatic operation, a machine-learned inference model is used to carry out, in real time, object recognition from a moving image captured by an in-vehicle camera, and control a vehicle in accordance with a result of the object recognition.

However, as disclosed in Non-patent Literature 1 below, in a case where object recognition from a moving image is carried out in real time, it is difficult, in consideration of calculation time for object detection, to cause all frames of the moving image to be an object recognition target. Thus, automatic operation is forced to be carried out on the basis of an object recognition result from some of the frames of the moving image.

### CITATION LIST

### Non-Patent Literature

[Non-patent Literature 1]
Mengtian Li et. al., Towards Streaming Perception, arXiv: 2005.10420v2, 2020

### SUMMARY OF INVENTION

### Technical Problem

In a case where some of the frames are excluded from the object recognition target and the frames thus excluded contain an image of a detection target, failure to detect the detection target may occur. Furthermore, a machine-learned inference model with higher inference accuracy generally involves a longer inference time. Thus, in a case where an inference model with low inference accuracy is applied to reduce the number of frames to be excluded from an object recognition target, erroneous recognition or recognition failure may occur due to insufficient inference accuracy.

That is, inference carried out by inputting, to an inference model, data constituting a time series has the following problem. Specifically, emphasis on a short inference time results in loss of stability of an inference result due to insufficient inference accuracy, whereas emphasis on inference accuracy results in an increase in data that cannot be processed. Such a problem not only may occur in object recognition from a moving image, but also may occur, in common, in inference carried out by inputting, to any inference model, any data constituting a time series.

An example aspect of the present invention has been made in view of the above problems, and an example object thereof is to provide, for example, an information processing apparatus capable of ensuring necessary inference accuracy, in inference carried out by inputting, to an inference model, data constituting a time series, while minimizing inference time.

### Solution to Problem

An information processing apparatus according to an example aspect of the present invention includes at least one processor, the at least one processor carrying out: a first difficulty calculation process for calculating, on the basis of input data constituting a time series, difficulty in inference carried out by inputting at least one piece of the input data to a first-stage inference model among multiple-stage inference models which are configured such that use of a later-stage inference model achieves higher inference accuracy; and a first determination process for determining, on the basis of the difficulty, whether a second- or later-stage inference model will be used for inference with use of the input data.

An information processing apparatus according to another example aspect of the present invention includes at least one processor, the at least one processor carrying out: a first difficulty calculation process for calculating, on the basis of training data constituting a time series, difficulty in inference carried out by inputting at least one piece of the training data to a first-stage inference model among multiple-stage inference models which are configured such that use of a later-stage inference model achieves higher inference accuracy; and a first determination process for determining, on the basis of the difficulty, whether the training data will be used for learning of a second- or later-stage inference model.

A determination method includes: (a) calculating, on the basis of input data constituting a time series, difficulty in inference carried out by inputting at least one piece of the input data to a first-stage inference model among multiple-stage inference models which are configured such that use of a later-stage inference model achieves higher inference accuracy; and (b) determining, on the basis of the difficulty, whether a second- or later-stage inference model will be used for inference with use of the input data, (a) and (b) each being carried out by at least one processor.

### Advantageous Effects of Invention

An example aspect of the present invention makes it possible to ensure necessary inference accuracy, in inference carried out by inputting, to an inference model, data constituting a time series, while minimizing inference time.

### BRIEF DESCRIPTION OF DRAWINGS

FIG. 1 shows block diagrams illustrating respective configurations of information processing apparatuses according to a first example embodiment of the present invention.

FIG. 2 shows flowcharts each illustrating a flow of a determination method according to the first example embodiment of the present invention.

FIG. 3 is a diagram illustrating an overview of a process carried out by an information processing apparatus according to a second example embodiment of the present invention.

FIG. 4 is a block diagram illustrating an example configuration of the information processing apparatus according to the second example embodiment of the present invention.

FIG. 5 is a block diagram illustrating an example configuration of a first-stage processing unit.

FIG. 6 is a block diagram illustrating another example configuration of the first-stage processing unit.

FIG. 7 is a flowchart illustrating a flow of a process carried out by the information processing apparatus during inference.

FIG. 8 is a flowchart illustrating a flow of a process carried out by the information processing apparatus during learning.

FIG. 9 is a drawing illustrating an example of a computer which executes instructions of a program that is software realizing functions of apparatuses according to example embodiments of the present invention.

### EXAMPLE EMBODIMENTS

### First Example Embodiment

A first example embodiment of the present invention will be described in detail with reference to the drawings. The first example embodiment is an embodiment serving as a basis for example embodiments described later.

(Configuration of Information Processing Apparatus)

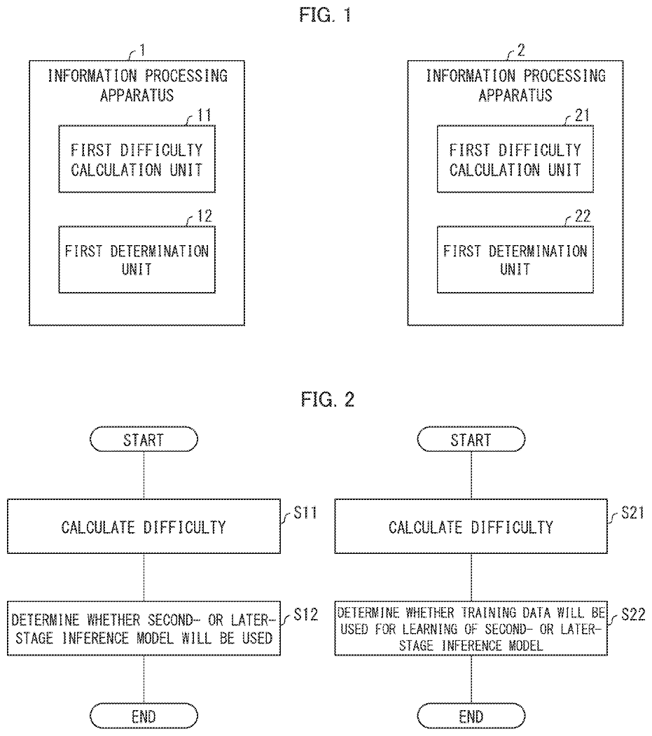

Information processing apparatuses 1 and 2 according to the first example embodiment will be described with reference to FIG. 1. FIG. 1 shows block diagrams illustrating respective configurations of the information processing apparatuses 1 and 2. The information processing apparatus 1 includes a first difficulty calculation unit 11 and a first determination unit 12 (see FIG. 1).

The first difficulty calculation unit 11 calculates, on the basis of input data constituting a time series, difficulty in inference carried out by inputting at least one piece of the input data to a first-stage inference model among multiple-stage inference models which are configured such that use of a later-stage inference model achieves higher inference accuracy.

The first determination unit 12 determines, on the basis of the difficulty calculated by the first difficulty calculation unit 11, whether a second- or later-stage inference model will be used for inference with use of the input data.

As described above, the information processing apparatus 1 according to the first example embodiment includes: the first difficulty calculation unit 11 that calculates, on the basis of input data constituting a time series, difficulty in inference carried out by inputting at least one piece of the input data to a first-stage inference model among multiple-stage inference models which are configured such that use of a later-stage inference model achieves higher inference accuracy; and the first determination unit 12 that determines, on the basis of the difficulty calculated by the first difficulty calculation unit 11, whether a second- or later-stage inference model will be used for inference with use of the input data. Thus, the information processing apparatus 1 according to the first example embodiment brings about an effect of making it possible to ensure necessary inference accuracy, in inference carried out by inputting, to an inference model, data constituting a time series, while minimizing inference time.

The information processing apparatus 2 includes a first difficulty calculation unit 21 and a first determination unit 22. The first difficulty calculation unit 21 calculates, on the basis of training data constituting a time series, difficulty in inference carried out by inputting at least one piece of the training data to a first-stage inference model among multiple-stage inference models which are configured such that use of a later-stage inference model achieves higher inference accuracy.

The first determination unit 22 determines, on the basis of the difficulty calculated by the first difficulty calculation unit 21, whether the training data will be used for learning of a second- or later-stage inference model.

As described above, the information processing apparatus 2 according to the first example embodiment includes: the first difficulty calculation unit 21 that calculates, on the basis of training data constituting a time series, difficulty in inference carried out by inputting at least one piece of the training data to a first-stage inference model among multiple-stage inference models which are configured such that use of a later-stage inference model achieves higher inference accuracy; and the first determination unit 22 that determines, on the basis of the difficulty calculated by the first difficulty calculation unit 21, whether the training data will be used for learning of a second- or later-stage inference model. Thus, the information processing apparatus 2 according to the first example embodiment makes it possible to generate multiple-stage inference models that make it possible to ensure necessary inference accuracy, in inference carried out by inputting, to an inference model, data constituting a time series, while minimizing inference time. Use of such an inference model makes it possible to ensure necessary inference accuracy while minimizing inference time.

(Determination Program)

The foregoing functions of the information processing apparatus 1 can also be realized by a program. A determination program according to the first example embodiment causes a computer to function as: the first difficulty calculation unit 11 that calculates, on the basis of input data constituting a time series, difficulty in inference carried out by inputting at least one piece of the input data to a first-stage inference model among multiple-stage inference models which are configured such that use of a later-stage inference model achieves higher inference accuracy; and the first determination unit 12 that determines, on the basis of the difficulty calculated by the first difficulty calculation unit 11, whether a second- or later-stage inference model will be used for inference with use of the input data. The determination program brings about an effect of making it possible to ensure necessary inference accuracy while minimizing inference time.

Similarly, the foregoing functions of the information processing apparatus 2 can also be realized by a program. Another determination program according to the first example embodiment causes a computer to function as: the first difficulty calculation unit 21 that calculates, on the basis of training data constituting a time series, difficulty in inference carried out by inputting at least one piece of the training data to a first-stage inference model among multiple-stage inference models which are configured such that use of a later-stage inference model achieves higher inference accuracy; and the first determination unit 22 that determines, on the basis of the difficulty calculated by the first difficulty calculation unit 21, whether the training data will be used for learning of a second- or later-stage inference model. The another determination program brings about an effect of making it possible to generate multiple-stage inference models that make it possible to ensure necessary inference accuracy while minimizing inference time.

(Flow of Determination Method)

A flow of a determination method according to the first example embodiment will be described with reference to FIG. 2. FIG. 2 shows flowcharts each illustrating the flow of the determination method. Note that steps of the determination method illustrated in FIG. 2 may be carried out by a processor of the information processing apparatus 1 or 2 or by a processor of another apparatus. Alternatively, the steps may be carried out by processors provided in respective different apparatuses.

In the flowchart shown on the left side of FIG. 2, in S11, at least one processor calculates, on the basis of input data constituting a time series, difficulty in inference carried out by inputting at least one piece of the input data to a first-stage inference model among multiple-stage inference models which are configured such that use of a later-stage inference model achieves higher inference accuracy.

In S12, the at least one processor determines, on the basis of the difficulty calculated in S11, whether a second- or later-stage inference model will be used for inference with use of the input data.

As described above, in the determination method according to the first example embodiment, at least one processor calculates, on the basis of input data constituting a time series, difficulty in inference carried out by inputting at least one piece of the input data to a first-stage inference model among multiple-stage inference models which are configured such that use of a later-stage inference model achieves higher inference accuracy, (S11); and the at least one processor determines, on the basis of the difficulty calculated in S11, whether a second- or later-stage inference model will be used for inference with use of the input data (S12). This brings about an effect of making it possible to ensure necessary inference accuracy while minimizing inference time.

In the flowchart shown on the right side of FIG. 2, in S21, at least one processor calculates, on the basis of training data constituting a time series, difficulty in inference carried out by inputting at least one piece of the training data to a first-stage inference model among multiple-stage inference models which are configured such that use of a later-stage inference model achieves higher inference accuracy.

In S22, the at least one processor determines, on the basis of the difficulty calculated in S21, whether the training data will be used for learning of a second- or later-stage inference model.

As described above, in the determination method according to the first example embodiment, at least one processor calculates, on the basis of training data constituting a time series, difficulty in inference carried out by inputting at least one piece of the training data to a first-stage inference model among multiple-stage inference models which are configured such that use of a later-stage inference model achieves higher inference accuracy (S21); and the at least one processor determines, on the basis of the difficulty calculated in S21, whether the training data will be used for learning of a second- or later-stage inference model (S22). This brings about an effect of making it possible to generate multiple-stage inference models that make it possible to ensure necessary inference accuracy while minimizing inference time.

### Second Example Embodiment

(Overview of Determination Method)

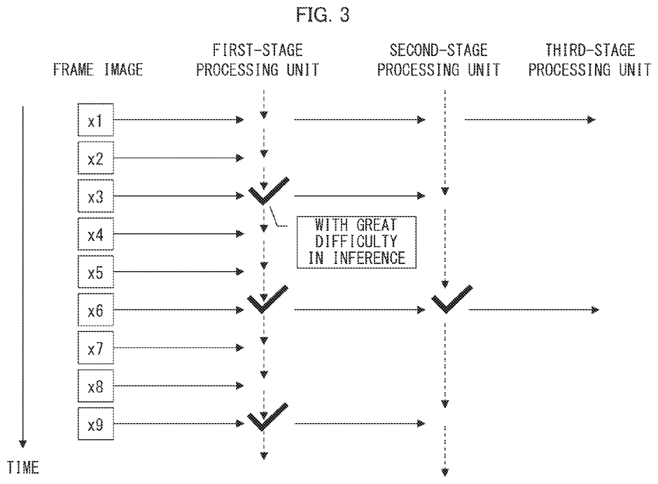

An overview of a process carried out by an information processing apparatus 3 according to a second example embodiment of the present invention will be described with reference to FIG. 3. FIG. 3 is a diagram illustrating the overview of the process carried out by the information processing apparatus 3 according to the second example embodiment.

The second example embodiment discusses an example in which a frame image extracted from a moving image is used as input data to carry out inference. The frame image is input data constituting a time series, and a new frame image is acquired with the passage of time. FIG. 3 illustrates a state in which frame images of x1 to x9 are sequentially acquired.

Note that details of inference are exemplified by but not particularly limited to detection and classification of an object in a frame image. It is a matter of course that the information processing apparatus 3 can use any time series data other than the frame image as the input data to carry out inference. Thus, the “frame image” in the following description can be read as any “input data” constituting a time series.

The information processing apparatus 3 includes a first-stage processing unit, a second-stage processing unit, and a third-stage processing unit, and uses these processing units to carries out inference. More specifically, the information processing apparatus 3 ordinarily uses the first-stage processing unit to carry out inference, uses the second-stage processing unit to carries out inference for a frame image posing great difficulty in inference for the first-stage processing unit, and uses the third-stage processing unit to carry out inference for a frame image posing great difficulty in inference for the second-stage processing unit.

The first-stage processing unit uses a first-stage inference model among three-stage inference models which are configured such that use of a later-stage inference model achieves higher inference accuracy. The second-stage processing unit uses a second-stage inference model, and the third-stage processing unit uses a third-stage inference model. Thus, among the three processing units, the first-stage processing unit has the shortest inference time while having the lowest inference accuracy, the third-stage processing unit has the longest inference time while having the highest inference accuracy, and the second-stage processing unit has (i) inference accuracy that is intermediate between the inference accuracy of the first-stage processing unit and the inference accuracy of the third-stage processing unit and (ii) inference time that is intermediate between the inference time of the first-stage processing unit and the inference time of the third-stage processing unit.

For example, it is determined that the frame image x3 illustrated in FIG. 3 poses great difficulty in inference for the first-stage processing unit. Thus, the second-stage processing unit carries out inference based on the frame image x3. Furthermore, it is determined that the frame image x6 not only poses great difficulty in inference for the first-stage processing unit but also poses great difficulty in inference for the second-stage processing unit. Thus, the third-stage processing unit carries out inference based on the frame image x6.

As described above, the information processing apparatus 3 uses the first-stage processing unit, which has a short inference time, to carry out inference for a frame image posing less difficulty in inference, such as the frame image x1, x2, x4, or x5. In contrast, the information processing apparatus 3 uses the second-stage processing unit having higher inference accuracy to carry out inference for a frame image posing great difficulty in inference for the first-stage processing unit, such as the frame image x3. The information processing apparatus 3 uses the third-stage processing unit having the highest inference accuracy to carry out inference for a frame image posing great difficulty in inference for the second-stage processing unit, such as the frame image x6.

With this, average processing time can be minimized in a case where the first-stage processing unit that has a short inference time processes, at a high speed, the frame image posing less difficulty in inference, and a deterioration in inference accuracy can be minimized in a case where the second-stage processing unit or the third-stage processing unit processes a frame image posing greater difficulty in inference. Thus, the information processing apparatus 3 makes it possible to ensure necessary inference accuracy while minimizing inference time. For example, the information processing apparatus 3 makes it possible to process all acquired frame images in real time.

(Configuration of Information Processing Apparatus)

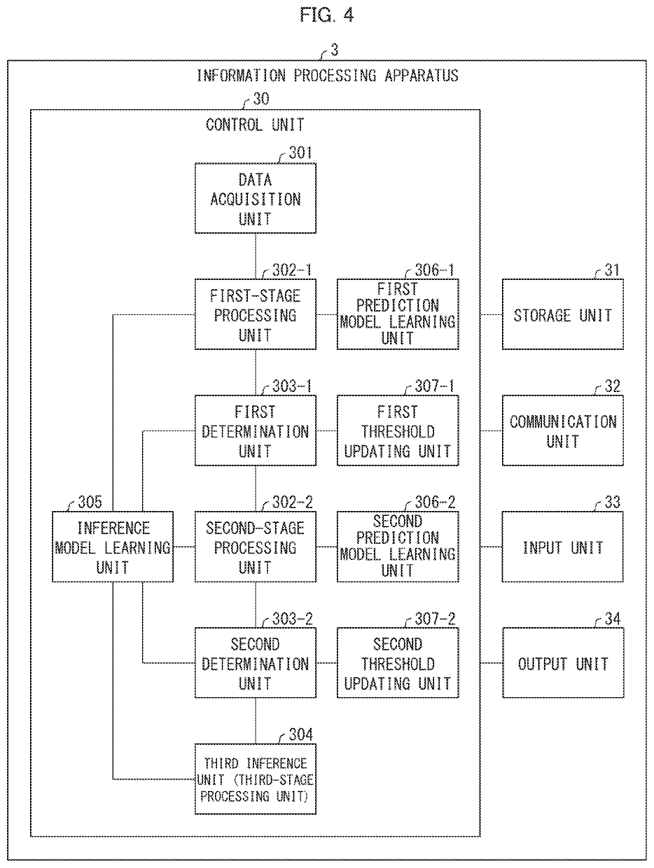

A configuration of the information processing apparatus 3 will be described with reference to FIG. 4. FIG. 4 is a block diagram illustrating an example configuration of the information processing apparatus 3. The information processing apparatus 3 includes a control unit 30 that collectively controls units of the information processing apparatus 3 and a storage unit 31 that stores various kinds of data used by the information processing apparatus 3. The information processing apparatus 3 further includes a communication unit 32 that allows the information processing apparatus 3 to communicate with another apparatus, an input unit 33 that receives an input of various kinds of data to the information processing apparatus 3, and an output unit 34 that allows the information processing apparatus 3 to output various kinds of data.

The control unit 30 includes a data acquisition unit 301, a first-stage processing unit 302-1, a second-stage processing unit 302-2, a first determination unit 303-1, a second determination unit 303-2, and a third inference unit 304. The control unit 30 further includes, as learning-related blocks, an inference model learning unit 305, a first prediction model learning unit 306-1, a second prediction model learning unit 306-2, a first threshold updating unit 307-1, and a second threshold updating unit 307-2.

Note that the first prediction model learning unit 306-1 and the second prediction model learning unit 306-2 will be described in (Updating of prediction model) described later. Note also that the first threshold updating unit 307-1 and the second threshold updating unit 307-2 will be described in (Updating of threshold) described later.

The data acquisition unit 301 acquires input data for use in inference. The data acquisition unit 301 acquires training data for learning of an inference model for use in inference. For example, the data acquisition unit 301 may acquire, as the input data, time-series frame images constituting a moving image, or may acquire training data in which ground truth data indicative of a ground truth of inference are associated with the respective time-series frame images.

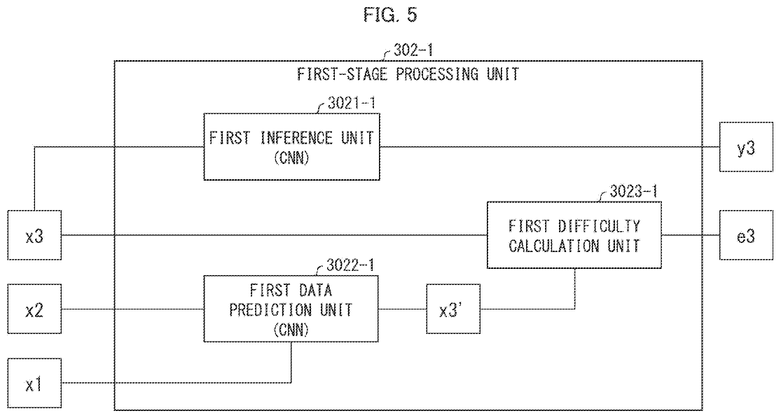

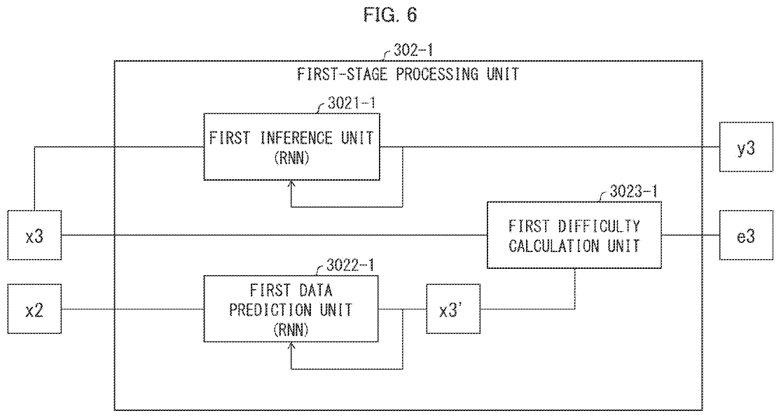

The first-stage processing unit 302-1 carries out inference by inputting, to the first-stage inference model among multiple-stage inference models which are configured such that use of a later-stage inference model achieves higher inference accuracy, at least one piece of the input data that is acquired by the data acquisition unit 301. The second-stage processing unit 302-2 uses the second-stage inference model among the multiple-stage inference models to carry out inference. Note that details of the first-stage processing unit 302-1 and the second-stage processing unit 302-2 will be described later with reference to FIGS. 5 and 6.

The first determination unit 303-1 determines whether a second- or later-stage inference model will be used. The second determination unit 303-2 determines whether the third-stage inference model will be used. Details of the above determinations will also be described later with reference to FIGS. 5 and 6.

The third inference unit 304 corresponds to the third-stage processing unit of FIG. 3. In a case where the second determination unit 303-2 determines that the third-stage inference model will be used, the third inference unit 304 uses the third-stage inference model among the multiple-stage inference models to carry out inference.

The inference model learning unit 305 carries out learning of the multiple-stage inference models. More specifically, the inference model learning unit 305 uses the training data acquired by the data acquisition unit 301 to update weighting values of each of the inference models. Learning of an inference model will be described in “Updating of prediction model” described later.

(Multiple-Stage Inference Models)

The multiple-stage inference models used by the information processing apparatus 3 only need to be configured such that use of a later-stage inference model achieves higher inference accuracy. The multiple-stage inference models may be generated by a method that is not particularly limited. For example, in the case of an inference model of a neural network, a larger number of intermediate layers basically achieve higher the inference accuracy. Thus, a plurality of inference models that are different in number of intermediate layers may be independently generated and used as the multiple-stage inference models.

The multiple-stage inference models may be generated on the basis of a single multilayer neural network model.

Assume, for example, that a convolutional neural network (CNN) is used to construct the three-stage inference models. In this case, after a single inference model is constructed, two additional output layers (referred to as “second and third output layers”) may be added between an input layer and an output layer (referred to as a “first output layer”) of the single inference model. Note that the second and third output layers are added at respective different positions. Inference by the first output layer can be referred to as a primary task, and inference by the second and third output layers can be referred to as an auxiliary task. An inference model as a whole from the input layer to the first output layer may serve as the third-stage inference model, a part of the inference model from the input layer to the second output layer may serve as the first-stage inference model, and a part of the inference model from the input layer to the third output layer may serve as the second-stage inference model.

For example, after a single inference model is constructed, a plurality of inference models may be generated by gradually compressing the single inference model. In this case, an uncompressed inference model may serve as the third-stage inference model, a one-level compressed inference model may serve as the second-stage inference model, and a two-level compressed inference model may serve as the first-stage inference model. A compression method is not particularly limited. For example, an inference model may be compressed by thinning out layers constituting the inference model.

In a case where a recurrent neural network (RNN) is used to construct an inference model, the multiple-stage inference models may be generated by gradually increasing the size of a neural network of internal processing that is recurrently carried out.

A structure of an earlier-stage inference model may be copied into some of later-stage inference models. In other words, a weighting value may be shared between the later-stage inference models and the earlier-stage inference model. Note that the weighting value can also be referred to as a model parameter.

Each of such methods as those described above makes it possible to generate the three-stage inference models in which inference accuracy gradually increases. Two-stage inference models or four- or more-stage inference models can also be similarly generated.

Use of multiple-stage inference models generated on the basis of a single multilayer neural network model also provides an advantage of making it possible to use an earlier-stage inference result to carry out later-stage inference, i.e., to start a later-stage process in such a manner that the later-stage process is resumed from the earlier-stage inference result. For example, a first feature value that is extracted from a frame image by the first-stage inference model may be used as input data for inference by the second-stage inference model. A second feature value that is extracted during inference by the second-stage inference model may be used as input data for inference by the third-stage inference model.

(First Example Configuration of First-Stage Processing Unit)

FIG. 5 is a block diagram illustrating an example configuration of the first-stage processing unit 302-1. The first-stage processing unit 302-1 includes a first inference unit 3021-1, a first data prediction unit 3022-1, and a first difficulty calculation unit 3023-1 (see FIG. 5).

Note that the second-stage processing unit 302-2 has a configuration similar to the configuration of the first-stage processing unit 302-1 and includes a second inference unit 3021-2, a second data prediction unit 3022-2, and a second difficulty calculation unit 3023-2. The information processing apparatus 3 may use four- or more-stage inference models. In this case, a processing unit as illustrated in FIG. 5 only needs to be provided for each of the first-stage inference model to an inference model at a stage, which is one stage earlier than a final stage. That is, an information processing apparatus in which (k+1)-stage inference models are used includes (i) k processing units from the first-stage processing unit 302-1 to a kth-stage processing unit 302-k and (ii) a (k+1)th inference unit that uses a (k+1)th-stage inference model to carry out inference. The kth-stage processing unit 302-k includes a kth inference unit 3021-k, a kth data prediction unit 3022-k, and a kth difficulty calculation unit 3023-k.

The first inference unit 3021-1 uses the first-stage inference model to carry out inference. The first inference unit 3021-1 may be configured to use an inference model of the CNN to carry out inference (see FIG. 5).

The first data prediction unit 3022-1 predicts a frame image for use in inference by the first-stage inference model among frame images constituting a time series, the frame image being predicted from a chronologically earlier frame image than the frame image. The first prediction model is used to predict the frame image.

The first prediction model is used to predict a frame image at a certain time point from a frame image chronologically earlier than the certain time point. The first prediction model may be a machine learning model generated by learning a relationship between those frame images, such as a neural network. For example, in a case where the first inference unit 3021-1 uses the inference model of the CNN, the first prediction model may also be a CNN model. Alternatively, for example, in a case where the first inference unit 3021-1 uses an inference model of the RNN, it is possible to add, to the inference model of the RNN, a layer in which internal processing for predicting input data is carried out. In this case, the first data prediction unit 3022-1 may use the inference model of the RNN to predict the input data.

During learning of the multiple-stage inference models, the first data prediction unit 3022-1 predicts training data at a certain time point (more accurately, a frame image included in the training data at the certain time point) among training data constituting a time series, the training data at the certain time point being predicted from training data at a time point chronologically earlier than the certain time point.

The first difficulty calculation unit 3023-1 calculates, on the basis of a frame image, difficulty in inference carried out by inputting the frame image to the first-stage inference model among the multiple-stage inference models. During learning of the multiple-stage inference models, the first difficulty calculation unit 3023-1 calculates, on the basis of training data (more accurately, a frame image included in the training data), difficulty in inference carried out by inputting the training data to the first-stage inference model among the multiple-stage inference models. More specifically, the first difficulty calculation unit 3023-1 calculates, as a value indicative of difficulty in inference, a prediction error of the first data prediction unit 3022-1.

For example, in a case where the frame image x3 is acquired, the first inference unit 3021-1 inputs the frame image x3 to the first-stage inference model and outputs an inference result y3 (see FIG. 5). In so doing, the first data prediction unit 3022-1 predicts the frame image x3 for use in inference by the first-stage inference model from the frame images x1 and x2, which are chronologically earlier frame images than the frame image x3. x3′ is a predicted frame image. The first difficulty calculation unit 3023-1 calculates a prediction error e3 of the first data prediction unit 3022-1 as a value indicative of difficulty in inference.

The prediction error may be calculated by a method that is not particularly limited. For example, the first difficulty calculation unit 3023-1 may use the frame images x3 and x3′ and an error function to calculate the prediction error. The error function may be, for example, a mean squared error (MSE) or KL-divergence.

In a case where the first difficulty calculation unit 3023-1 calculates the prediction error, the first determination unit 303-1 determines, on the basis of the calculated prediction error e3, whether the second-stage inference model will be used. For example, the first determination unit 303-1 may determine, in a case where the prediction error e3 exceeds a predetermined first threshold, that the second-stage inference model will be used. A condition under which the second-stage inference model is used is expressed as f(x3)=e3>th where f(x) represents the error function, and th represents the first threshold.

As described above, the information processing apparatus 3 includes the first data prediction unit 3022-1 that predicts a frame image that is input data which is input to the first-stage inference model, the frame image being predicted from a chronologically earlier frame image (past input data) than the frame image. The first difficulty calculation unit 3023-1 calculates the prediction error of the first data prediction unit 3022-1 as a value indicative of difficulty in inference by the first-stage inference model.

A sudden change in input data generally easily results in a deterioration in accuracy of inference with use of a value of the input data. A sudden change in input data also generally increases the above-described prediction error. Thus, the information processing apparatus 3 according to the first example embodiment brings about not only the effect brought about by the information processing apparatus 1 according to the first example embodiment but also an effect of making it possible to use the second- or later-stage inference model in a case where accuracy of inference is expected to deteriorate.

In a case where the first determination unit 303-1 determines that the second-stage inference model will be used, the second-stage processing unit 302-2 carries out a process. In this case, the second inference unit 3021-2 included in the second-stage processing unit 302-2 may carry out inference by inputting, to the second-stage inference model, the first feature value extracted during inference by the first inference unit 3021-1.

The information processing apparatus 3 thus includes: the first inference unit 3021-1 that carries out inference by inputting the input data to the first-stage inference model; and the second inference unit 3021-2 that, in a case where the first determination unit 303-1 determines that the second-stage inference model will be used, carries out inference by inputting, to the second-stage inference model, the first feature value extracted during inference by the first inference unit 3021-1. Thus, the information processing apparatus 3 according to the first example embodiment brings about not only the effect brought about by the information processing apparatus 1 according to the first example embodiment but also an effect of making it possible to carry out, in inference with use of the second-stage inference model, efficient inference in which the first feature value is effectively used.

The information processing apparatus 3 further includes: the second data prediction unit 3022-2 that predicts the first feature value with use of a feature value extracted from a chronologically earlier frame image (past input data) than a frame image from which the first feature value has been extracted; the second difficulty calculation unit 3023-2 that calculates a prediction error of the second data prediction unit 3022-2 as a value indicative of difficulty in inference with use of the second-stage inference model; and the second determination unit 303-2 that determines, on the basis of the prediction error that is calculated by the second difficulty calculation unit 3023-2, whether a third- or later-stage inference model will be used.

As described earlier, a sudden change in input data generally not only easily results in a deterioration in accuracy of inference with use of a value of the input data but also increases the prediction error. Thus, the above configuration brings about an effect of making it possible to use the third- or later-stage inference model in a case where accuracy of inference by the second-stage inference model is expected to deteriorate.

Note that the second data prediction unit 3022-2 may use the RNN model to predict the first feature value. In the RNN model, input data of past time can be held and used for prediction calculation. With this, the first feature value can be predicted with stable accuracy even in a case where the past input data for use in prediction varies because inference with use of the second-stage inference model is carried out at irregular timings.

For example, in the example of FIG. 3, the second-stage processing unit 302-2 carries out a process related to the frame image x3 and then carries out a process related to the frame image x6. In this case, the second data prediction unit 3022-2 can output an appropriate prediction result by using the RNN model in which the first feature value extracted from the frame image x3 is held to predict the first feature value to be extracted from the frame image x6.

The second data prediction unit 3022-2 may use the CNN model to predict the first feature value. In this case, the second data prediction unit 3022-2 may hold the first feature value extracted from a past frame image, and use the first feature value for prediction calculation. For example, the second data prediction unit 3022-2 may predict the first feature value by using, as the input data, first feature values extracted from frame images at respective times and connected in a channel direction. A moving image to be used to generate the first feature value has any length. It is only necessary to extract frame images from a moving image having a predetermined length, and hold first feature values extracted from those frame images.

Assume, for example, that the first feature values for two frames are held in the example of FIG. 3. In this case, the second-stage processing unit 302-2 uses the first feature value extracted from the frame image x1 and the first feature value extracted from the frame image x3 to predict the first feature value to be extracted from the frame image x6.

In a case where a degree of environmental change such as a change of a target object in the frame image is reflected in the prediction error, the degree of environmental change occurring when the prediction error exceeds the first threshold is considered to fall within a certain range. Thus, it is not necessarily necessary to use the RNN model or the first feature values extracted from a plurality of frame images to predict the first feature value.

The first determination unit 303-1 may determine, on the basis of the difficulty calculated by the first difficulty calculation unit 3023-1, which of second- or later-stage inference models will be used for inference with use of the input data. This makes it possible to use an inference model at a stage in accordance with difficulty. For example, inference with great difficulty for either the first-stage or second-stage inference model can be carried out by the third-stage inference model while inference by the second-stage inference model is omitted.

A relationship between difficulty in inference and the inference model to be used only needs to be defined in advance. For example, the first-stage inference model may be used in a case where the prediction error indicative of difficulty in inference is not more than a threshold th1, the second-stage inference model may be used in a case where the prediction error is more than the threshold th1 and not more than a threshold th2 (th1<th2), and the third-stage inference model may be used in a case where the prediction error is more than the threshold th2.

(Second Example Configuration of First-Stage Processing Unit)

FIG. 6 is a block diagram illustrating another example configuration of the first-stage processing unit 302-1. The first-stage processing unit 302-1 illustrated in FIG. 6 is different from the first-stage processing unit 302-1 in FIG. 5 in that the first inference unit 3021-1 and the first data prediction unit 3022-1 use the RNN model to carry out inference and prediction. Note that, since a process carried out by the first difficulty calculation unit 3023-1 is similar to the example of FIG. 5, a description thereof is not repeated here.

The first data prediction unit 3022-1 that uses the RNN model to carry out prediction may use only the frame image x2, which is one time earlier than the frame image x3 used by the first inference unit 3021-1 for inference, to predict the frame image x3 (see FIG. 6). The RNN model enables the past input data (x2 and earlier frame images) to be reflected as an internal state of the RNN model. Thus, even in a case where only the frame image x2 is used as the input data, it is possible to carry out prediction in consideration also of, for example, the frame image x1.

The second inference unit 3021-2 that uses the RNN model may also carry out inference, as in the case of using the CNN model, by inputting, to the second-stage inference model, the first feature value extracted during inference by the first inference unit 3021-1. Similarly, the third inference unit 304 may carry out inference by inputting, to the third-stage inference model, the second feature value extracted during inference by the second inference unit 3021-2.

The second data prediction unit 3022-2 may predict the first feature value, which is the input data that is input to the second-stage inference model, from the first feature value (past input data) extracted from the frame image chronologically earlier than the first feature value to be predicted by the second data prediction unit 3022-2. For example, the second data prediction unit 3022-2 may predict, from the first feature value extracted from the frame image x2, the first feature value extracted from the frame image x3.

(Flow of Process Related to Inference)

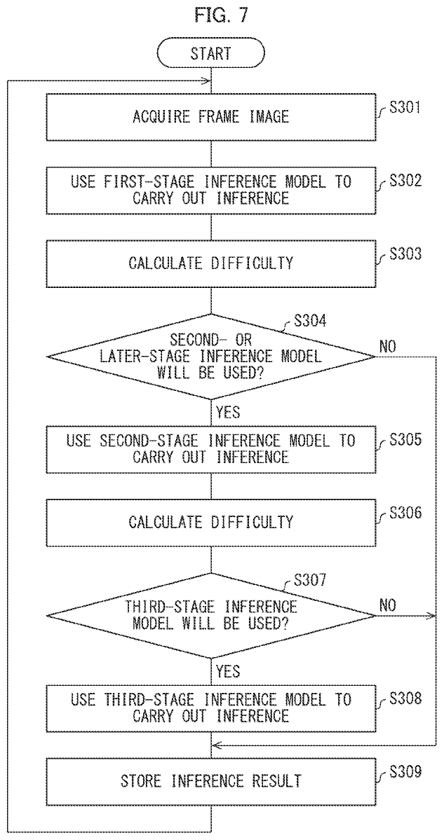

FIG. 7 is a flowchart illustrating a flow of a process carried out by the information processing apparatus 3 during inference. FIG. 7 illustrates a flow of a process related to inference to be carried out with respect to frame images in second or later frames. It is impossible for the kth data prediction unit 3022-k to predict a frame image in a first frame. Thus, it is only necessary to determine in advance an inference model for use in inference with use of the frame image in the first frame. For example, the frame image in the first frame may be subjected to inference with use of third- and earlier-stage inference models, or may be subjected to inference with use of the first-stage inference model. FIG. 7 illustrates an example in which three-stage inference models are used. Note, however, that inference with use of two-stage or four- or more-stage inference models can also be realized by a similar flow.

In S301, the data acquisition unit 301 acquires a frame image. Subsequently, in S302, the first inference unit 3021-1 included in the first-stage processing unit 302-1 uses the first-stage inference model to carry out inference. For example, the first inference unit 3021-1 may input, to the first-stage inference model, the frame image acquired in S301, and cause the first-stage inference model to output an inference result. Alternatively, for example, the first inference unit 3021-1 may input, to the first-stage inference model, the frame image acquired in S301 and at least one chronologically earlier image than the frame image, and cause the first-stage inference model to output the inference result.

In S303, the first difficulty calculation unit 3023-1 calculates, on the basis of the frame image acquired in S301, difficulty in inference by the first-stage inference model. More specifically, in S303, first, the first data prediction unit 3022-1 predicts, from the at least one chronologically earlier image than the frame image acquired in S301, the frame image acquired in S301. The first difficulty calculation unit 3023-1 calculates the prediction error of the first data prediction unit 3022-1 on the basis of the frame image predicted by the first data prediction unit 3022-1 and the frame image acquired in S301. This prediction error indicates the difficulty in inference by the first-stage inference model.

In S304, the first determination unit 303-1 determines, on the basis of the difficulty calculated in S303, whether a second- or later-stage inference model will be used. For example, the first determination unit 303-1 may determine, in a case where the difficulty calculated in S303 exceeds the first threshold, that the second- or later-stage inference model will be used.

In a case a determination result in S304 is YES, the process proceeds to S305. In contrast, in a case where the determination result in S304 is NO, the process proceeds to S309. In S309 to which the process has transitioned from S304, the first inference unit 3021-1 stores a result of inference in S302 in, for example, the storage unit 31. Thereafter, the process returns to S301, in which the next frame image is acquired. Note that the information processing apparatus 3 may output an inference result in S309 via, for example, the output unit 34, or may automatically carry out a process in accordance with the inference result. This also applies to a case (described later) where the process transitions to S309 from S307 or S308.

In S305, the second inference unit 3021-2 included in the second-stage processing unit 302-2 uses the second-stage inference model to carry out inference. More specifically, the second inference unit 3021-2 carries out inference by inputting, to the second-stage inference model, the first feature value extracted during inference by the first inference unit 3021-1 in S302. Note that the second inference unit 3021-2 may carry out inference by inputting, to the second-stage inference model, the frame image acquired in S301.

In S306, the second difficulty calculation unit 3023-2 calculates difficulty in inference by the second-stage inference model. More specifically, in S306, first, the second data prediction unit 3022-2 predicts, from the first feature value extracted during inference from the at least one chronologically earlier frame image than the frame image acquired in S301, the first feature value extracted during inference in S302. The second difficulty calculation unit 3023-2 calculates the prediction error of the second data prediction unit 3022-2 on the basis of the first feature value predicted by the second data prediction unit 3022-2 and the first feature value extracted during inference in S302. This prediction error indicates the difficulty in inference by the second-stage inference model.

In S307, the second determination unit 303-2 determines, on the basis of the difficulty calculated in S306, whether the third-stage inference model will be used. For example, the second determination unit 303-2 may determine, in a case where the difficulty calculated in S306 exceeds a second threshold value set in advance, that the third-stage inference model will be used.

In a case where a determination result in S307 is YES, the process proceeds to S308. In contrast, in a case where the determination result in S307 is NO, the process proceeds to S309. In S309 to which the process has transitioned from S307, the second inference unit 3021-2 stores a result of inference in S305 in, for example, the storage unit 31. Thereafter, the process returns to S301, in which the next frame image is acquired.

In S308, the third inference unit 304 uses the third-stage inference model to carry out inference. More specifically, the third inference unit 304 carries out inference by inputting, to the third-stage inference model, the second feature value extracted during inference by the second inference unit 3021-2 in S305. Note that the third inference unit 304 may carry out inference by inputting, to the third-stage inference model, the frame image acquired in S301. In S309 to which the process has transitioned from S308, the third inference unit 304 stores a result of inference in S308 in, for example, the storage unit 31. Thereafter, the process returns to S301, in which the next frame image is acquired.

(Flow of Process Related to Learning)

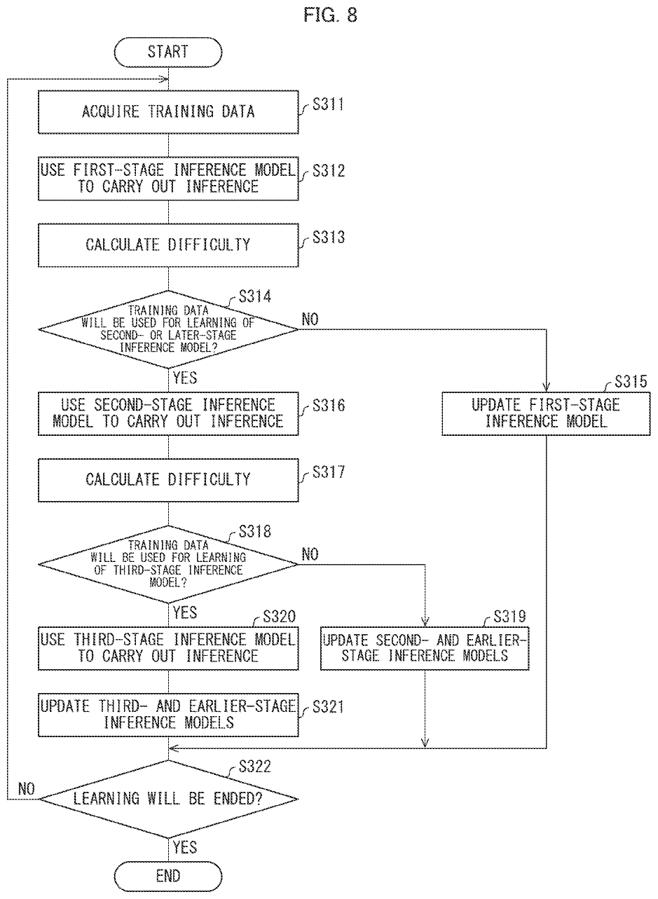

FIG. 8 is a flowchart illustrating a flow of a process carried out by the information processing apparatus 3 during learning. Note that the process of FIG. 8 is carried out after a training data set including a plurality of pieces of training data is acquired. The training data is data in which a frame image is associated with ground truth data indicative of a ground truth of inference with use of the frame image. Each frame image included in the training data set constitutes a time series. For example, in a case where a frame image extracted from a moving image is used to detect an object and classify the detected object, the training data may be used in which time-series frame images extracted from the moving image are associated with a position and a range of the object in the time-series frame images and a classification of the object as the ground truth data.

Note that the training data set may be acquired by a method which is not particularly limited. For example, the data acquisition unit 301 may acquire the training data set from another apparatus via the communication unit 32, or may acquire the training data set that is input via the input unit 33. Furthermore, multiple-stage inference models that allow inference with a certain degree of accuracy are used. For example, the multiple-stage inference models may be pre-learned models. FIG. 8 illustrates an example in which learning of three-stage inference models is carried out. Note, however, that learning of two-stage or four- or more-stage inference models can also be realized by a similar flow.

In S311, the first inference unit 3021-1 acquires one piece of the training data from the training data set described earlier. Then, in S312, the first inference unit 3021-1 uses, as input data, the frame image included in the training data acquired in S311, and uses the first-stage inference model to carry out inference.

Note that FIG. 8 illustrates a process in a case where the training data including a chronologically second or later frame image is acquired in S311. It is only necessary to determine in advance which of the inference models is to be learned with use of the training data including a chronologically first frame image. For example, the training data including the chronologically first frame image may be used for learning of the third- and earlier-stage inference models, or may be used for learning of a first- or earlier-stage inference model.

In S313, the first difficulty calculation unit 3023-1 calculates, on the basis of the frame image included in the training data acquired in S311, difficulty in inference by the first-stage inference model with use of the frame image. More specifically, in S313, first, the first data prediction unit 3022-1 predicts, from a chronologically earlier image than the frame image included in the training data acquired in S311, the frame image included in the training data acquired in S311. The first difficulty calculation unit 3023-1 calculates the prediction error of the first data prediction unit 3022-1 on the basis of the frame image predicted by the first data prediction unit 3022-1 and the frame image included in the training data acquired in S311. This prediction error indicates the difficulty in inference by the first-stage inference model.

In S314, the first determination unit 303-1 determines, on the basis of the difficulty calculated in S313, whether the training data acquired in S311 will be used for learning of the second- or later-stage inference model. For example, the first determination unit 303-1 may determine, in a case where the difficulty calculated in S313 exceeds the first threshold value set in advance, that the training data acquired in S311 will be used for learning of the second- or later-stage inference model. In a case where a determination result in S314 is YES, the process proceeds to S316. In contrast, in a case where the determination result in S314 is NO, the process proceeds to S315.

In S315, the inference model learning unit 305 updates the first-stage inference model. For example, the inference model learning unit 305 may use the ground truth data included in the training data acquired in S311 to calculate an error of a result of inference in S312, calculate, from the calculated error, a gradient of each weighting value included in the first-stage inference model, and update the each weighting value on the basis of the calculated gradient. In this case, for example, error back propagation is applicable to calculation of the gradient, and, for example, stochastic gradient descent is applicable to updating of the weighting value. After S315 ends, the process proceeds to S322.

In S316, the second inference unit 3021-2 included in the second-stage processing unit 302-2 uses the second-stage inference model to carry out inference. More specifically, the second inference unit 3021-2 carries out inference by inputting, to the second-stage inference model, the first feature value extracted during inference by the first inference unit 3021-1 in S312. Note that the second inference unit 3021-2 may carry out inference by inputting, to the second-stage inference model, the frame image included in the training data acquired in S311.

In S317, the second difficulty calculation unit 3023-2 calculates difficulty in inference by the second-stage inference model. More specifically, in S317, first, the second data prediction unit 3022-2 predicts, from the first feature value extracted during inference from the chronologically earlier frame image than the frame image included in the training data acquired in S311, the first feature value extracted from the frame image included in the training data acquired in S311. The second difficulty calculation unit 3023-2 calculates the prediction error of the second data prediction unit 3022-2 on the basis of the first feature value predicted by the second data prediction unit 3022-2 and the first feature value extracted during inference in S316. This prediction error indicates the difficulty in inference by the second-stage inference model.

In S318, the second determination unit 303-2 determines, on the basis of the difficulty calculated in S317, whether the training data acquired in S311 will be used for learning of the second- or later-stage inference model. For example, the second determination unit 303-2 may determine, in a case where the difficulty calculated in S317 exceeds the second threshold value set in advance, that the training data acquired in S311 will be used for learning of the third-stage inference model. In a case where a determination result in S318 is YES, the process proceeds to S320. In contrast, in a case where the determination result in S318 is NO, the process proceeds to S319.

In S319, the inference model learning unit 305 updates second- and earlier-stage inference models. For example, the inference model learning unit 305 may use the ground truth data included in the training data acquired in S311 to calculate an error of a result of inference in S316, calculate, from the calculated error, a gradient of each model parameter (can also be referred to as weighting value) included in the second- and earlier-stage inference models, and update the each weighting value on the basis of the calculated gradient. In this case, for example, error back propagation is applicable to calculation of the gradient, and, for example, stochastic gradient descent is applicable to updating of the weighting value. After S319 ends, the process proceeds to S322.

In S319, in a case where the multiple-stage inference models have been generated on the basis of a single multilayer neural network model, the inference model learning unit 305 may also update the weighting value of the earlier-stage inference model in learning of the second-stage inference model. For example, in a case where the inference model learning unit 305 applies error back propagation to update the weighting value of the second-stage inference model in S319, the weighting value of the first-stage inference model is also updated. Thus, end-to-end learning can be carried out in learning of the multiple-stage inference models. This makes it possible to intensively advance learning of the earlier-stage inference model while using the training data with great difficulty in inference for later-stage learning. Note that this also applies to the process of S321 described below.

In S320, the third inference unit 304 uses the third-stage inference model to carry out inference. More specifically, the third inference unit 304 carries out inference by inputting, to the third-stage inference model, the second feature value extracted during inference by the second inference unit 3021-2 in S316. Note that the third inference unit 304 may carry out inference by inputting, to the third-stage inference model, the frame image included in the training data acquired in S311.

In S321, the inference model learning unit 305 updates the third- and earlier-stage inference models. For example, the inference model learning unit 305 may use the ground truth data included in the training data acquired in S311 to calculate an error of a result of inference in S320, calculate, from the calculated error, a gradient of each weighting value included in the third- and earlier-stage inference models, and update the each weighting value on the basis of the calculated gradient. In this case, for example, error back propagation is applicable to calculation of the gradient, and, for example, stochastic gradient descent is applicable to updating of the weighting value. In a case where error back propagation is applied to update the inference model, weighting values of the first-stage and second-stage inference models are also updated in S321. After S321 ends, the process proceeds to S322.

In S322, the inference model learning unit 305 determines whether learning will be ended. In a case where a determination result in S322 is YES, the process of FIG. 8 ends. In contrast, in a case where the determination result in S322 is NO, the process returns to S311, in which the training data including the chronologically next frame image is acquired. Note that a condition under which learning is ended may be determined in advance. For example, the inference model learning unit 305 may end learning on condition that the number of times the inference model is updated has reached a given number.

As described above, a process carried out by the information processing apparatus 3 during learning, that is, a method of generating the inference model includes: calculating, on the basis of training data constituting a time series, difficulty in inference carried out by inputting at least one piece of the training data to a first-stage inference model among multiple-stage inference models (S313); and determining, on the basis of the calculated difficulty, whether the training data will be used for learning of a second- or later-stage inference model (S314).

The above configuration allows learning specialized for training data with less difficulty in inference to be carried out for the first-stage inference model. This makes it possible to prevent a deterioration in inference accuracy caused by using training data with great difficulty in inference to learn the first-stage inference model that is used to process input data with less difficulty in inference. Since training data with great difficulty in inference is used for learning of the second- or later-stage inference model, inference accuracy of the second- or later-stage inference model can also be effectively increased. Thus, the method of generating the inference model makes it possible to generate multiple-stage inference models suitable for inference by the information processing apparatus 3.

(Updating of Threshold)

During the process of FIG. 8, the first threshold updating unit 307-1 may update the first threshold for use in determination in S314. Similarly, the second threshold updating unit 307-2 may update the second threshold for use in determination in S318.

The first threshold and the second threshold may be updated such that each frame image included in the training data set used for learning is assigned to a corresponding appropriate processing unit (the first-stage processing unit 302-1, the second-stage processing unit 302-2, or the third inference unit 304) on the basis of difficulty in inference with use of the frame image.

For example, the first threshold updating unit 307-1 may specify, among pieces of the training data used to update the inference model in S315, a piece in which the error of the inference result exceeds a predetermined upper limit. The first threshold updating unit 307-1 may update the first threshold so that the determination result in S314 for the specified piece of the training data is YES. This makes it possible to increase the possibility that the second- or later-stage inference model will be used for inference about a frame image posing great difficulty in inference for the first-stage inference model.

Similarly, the second threshold updating unit 307-2 may specify, among pieces of the training data used to update the inference model in S319, a piece in which the error of the inference result exceeds a predetermined upper limit. The second threshold updating unit 307-2 may update the second threshold so that the determination result in S318 for the specified piece of the training data is YES. This makes it possible to increase the possibility that the third-stage inference model will be used for inference about a frame image posing great difficulty in inference for the second-stage inference model.

The first threshold updating unit 307-1 may specify, among pieces of the training data used to update the inference model in S319, a piece in which the error of the inference result is less than a predetermined lower limit. The first threshold updating unit 307-1 may update the first threshold so that the determination result in S314 for the specified piece of the training data is NO. This makes it possible to increase the possibility that the first-stage inference model will be used for inference about a frame image which poses less difficulty in inference for the second-stage inference model and for which inference is considered to be feasible with sufficient accuracy even with use of the first-stage inference model.

Similarly, the second threshold updating unit 307-2 may specify, among pieces of the training data used to update the inference model in S321, a piece in which the error of the inference result is less than a predetermined lower limit. The second threshold updating unit 307-2 may update the second threshold so that the determination result in S318 for the specified piece of the training data is NO. This makes it possible to increase the possibility that the second-stage inference model will be used for inference about a frame image which poses less difficulty in inference for the third-stage inference model and for which inference is considered to be feasible with sufficient accuracy even with use of the second-stage inference model.

As described above, the first determination unit 303-1 may determine that the training data in which the difficulty calculated by the first difficulty calculation unit 3023-1 exceeds the first threshold will be used for learning of the second- or later-stage inference model. The information processing apparatus 3 may include the first threshold updating unit 307-1 that updates the first threshold on the basis of a plurality of results of inference that are obtained by inputting, to the first-stage inference model, the training data constituting the time series.

The above configuration makes it possible to more accurately determine, on the basis of an actual inference result, whether the training data will be used for learning of the first-stage inference model or for learning of the second- or later-stage inference model, that is, to use, for learning of the first-stage inference model, training data that is expected to allow achievement of appropriate inference with use of the first-stage inference model, and to use, for learning of the second-stage inference model, training data that is expected to prevent obtainment of an appropriate inference result with use of the first-stage inference model.

Furthermore, as described above, the information processing apparatus 3 may include the second threshold updating unit 307-2 that updates the second threshold on the basis of a plurality of results of inference that are obtained by inputting, to the second-stage inference model, the training data constituting the time series. The above configuration makes it possible to use, for learning of the second-stage inference model, training data that is expected to allow obtainment of an appropriate inference result with use of the second-stage inference model, and to use, for learning of the third-stage inference model, training data that is expected to prevent obtainment of an appropriate inference result with use of the second-stage inference model. Note that threshold updating units may also be provided for respective third- or later-stage inference models in a case where four- or more-stage inference models are used.

(Updating of Prediction Model)

During the process of FIG. 8, the first prediction model used by the first data prediction unit 3022-1 and the second prediction model used by the second data prediction unit 3022-2 may also be updated. The first prediction model learning unit 306-1 updates the first prediction model, and the second prediction model learning unit 306-2 updates the second prediction model. Note that prediction model learning units may also be provided for respective third- or later-stage inference models in a case where four- or more-stage inference models are used.

Specifically, for example, the first prediction model learning unit 306-1 may calculate, from the prediction error calculated by the first difficulty calculation unit 3023-1 in S313, a gradient of each weighting value included in the first prediction model, and update the each weighting value on the basis of the calculated gradient. Similarly, the second prediction model learning unit 306-2 may calculate, from the prediction error calculated by the second difficulty calculation unit 3023-2 in S317, a gradient of each weighting value included in the second prediction model, and update the each weighting value on the basis of the calculated gradient. Note that for example, error back propagation is applicable to calculation of the gradient, and, for example, stochastic gradient descent is applicable to updating of the weighting value.

The first prediction model may be updated also after S303 in FIG. 7. Similarly, the second prediction model may be updated also after S306 in FIG. 7. Note that the first prediction model and the second prediction model may be updated at any timing that is not limited to these examples.

As described above, the information processing apparatus 3 includes the first data prediction unit 3022-1 that uses a first prediction model to predict training data at a certain time point among the training data constituting the time series, the training data at the certain time point being predicted from training data at a time point chronologically earlier than the certain time point. The first difficulty calculation unit 3023-1 calculates, as a value indicative of difficulty in inference with use of the training data at the certain time point, a prediction error of the first data prediction unit 3022-1. The information processing apparatus 3 includes the first prediction model learning unit 306-1 that uses learning with use of the training data constituting the time series to update the first prediction model so that the prediction error is decreased.

According to the above configuration, the first prediction model is updated so that the prediction error is decreased. This makes it possible to more accurately determine whether the training data will be used for learning of the first-stage inference model or for learning of the second- or later-stage inference model.

[Variation]

The processes described in the foregoing example embodiments may be carried out by any entity, which is not limited to the foregoing examples. That is, an information processing system including functions similar to the functions of the information processing apparatuses 1 to 3 can be constructed by a plurality of apparatuses that can communicate with each other. For example, the processes in the flowchart illustrated in FIG. 7 or FIG. 8 can be carried out by being shared between a plurality of information processing apparatuses (or processors).

The information processing apparatuses 1 to 3 and the like described in the foregoing example embodiments are suitably applicable to, for example, (i) real-time object detection from a frame image captured by a high-speed camera or (ii) real-time region segmentation in the frame image. Then, use of a result of such detection or region segmentation enables high-speed appearance inspection or high-speed environment recognition. The information processing apparatuses 1 to 3 and the like described in the foregoing example embodiments are suitably applicable also to, for example, an application in which an ambient environment is recognized from an image captured by an in-vehicle camera or a camera mounted on an unmanned mobile unit such as a drone. Furthermore, the information processing apparatuses 1 to 3 and the like described in the foregoing example embodiments are suitably applicable also to, for example, automatic operation.

[Software Implementation Example]

Some or all of the functions of each of the information processing apparatuses 1 to 3 may be realized by hardware such as an integrated circuit (IC chip) or may be alternatively realized by software.

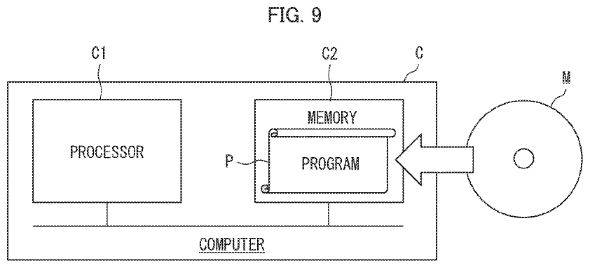

In the latter case, the information processing apparatuses 1 to 3 are each realized by, for example, a computer that executes instructions of a program that is software realizing the functions. FIG. 9 illustrates an example of such a computer (hereinafter referred to as “computer C”). The computer C includes at least one processor C1 and at least one memory C2. The memory C2 stores a program (determination program) P for causing the computer C to operate as each of the information processing apparatuses 1 to 3. In the computer C, the functions of each of the information processing apparatuses 1 to 3 are realized by the processor C1 reading the program P from the memory C2 and executing the program P.

The processor C1 may be, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof. The memory C2 may be, for example, a flash memory, a hard disk drive (HDD), a solid state drive (SSD), or a combination thereof.

Note that the computer C may further include a random access memory (RAM) in which the program P is loaded when executed and/or in which various kinds of data are temporarily stored. The computer C may further include a communication interface for transmitting and receiving data to and from another apparatus. The computer C may further include an input/output interface for connecting the computer C to an input/output apparatus(es) such as a keyboard, a mouse, a display, and/or a printer.

The program P can also be recorded in a non-transitory tangible storage medium M from which the computer C can read the program P. Such a storage medium M may be, for example, a tape, a disk, a card, a semiconductor memory, a programmable logic circuit, or the like. The computer C can acquire the program P via the storage medium M. The program P can also be transmitted via a transmission medium. The transmission medium may be, for example, a communication network, a broadcast wave, or the like. The computer C can acquire the program P also via such a transmission medium.

[Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

[Additional Remark 2]

The whole or part of the example embodiments disclosed above can also be described as below. Note, however, that the present invention is not limited to the following supplementary notes.

(Supplementary Note 1)

An information processing apparatus including: a first difficulty calculation means that calculates, on the basis of input data constituting a time series, difficulty in inference carried out by inputting at least one piece of the input data to a first-stage inference model among multiple-stage inference models which are configured such that use of a later-stage inference model achieves higher inference accuracy; and a first determination means that determines, on the basis of the difficulty, whether a second- or later-stage inference model will be used for inference with use of the input data.

(Supplementary Note 2)

An information processing apparatus according to Supplementary note 1, further including a first data prediction means that predicts the input data that is input to the first-stage inference model, the input data being predicted from past input data that is chronologically earlier than the input data, the first difficulty calculation means calculating, as a value indicative of the difficulty in inference, a prediction error of the first data prediction means.

(Supplementary Note 3)

An information processing apparatus including: a first difficulty calculation means that calculates, on the basis of training data constituting a time series, difficulty in inference carried out by inputting at least one piece of the training data to a first-stage inference model among multiple-stage inference models which are configured such that use of a later-stage inference model achieves higher inference accuracy; and a first determination means that determines, on the basis of the difficulty, whether the training data will be used for learning of a second- or later-stage inference model.

(Supplementary Note 4)

The information processing apparatus according to Supplementary note 3, wherein the multiple-stage inference models are generated on the basis of a single multilayer neural network model, the information processing apparatus further including an inference model learning means that also updates a weighting value of an earlier-stage inference model in learning of the second- or later-stage inference model.

(Supplementary Note 5)

An information processing apparatus according to Supplementary note 3 or 4, further including a first data prediction means that uses a first prediction model to predict training data at a certain time point among the training data constituting the time series, the training data at the certain time point being predicted from training data at a time point chronologically earlier than the certain time point, wherein the first difficulty calculation means calculates, as a value indicative of difficulty in inference with use of the training data at the certain time point, a prediction error of the first data prediction means, the information processing apparatus further including a first prediction model learning means that uses learning with use of the training data constituting the time series to update the first prediction model so that the prediction error is decreased.

(Supplementary Note 6)

The information processing apparatus according to any one of Supplementary notes 3 through 5, wherein the first determination means determines that the training data in which the difficulty exceeds a first threshold will be used for learning of the second- or later-stage inference model, the information processing apparatus further including a first threshold updating means that updates the first threshold on the basis of a plurality of results of inference that are obtained by inputting, to the first-stage inference model, the training data constituting the time series.

(Supplementary Note 7)

A determination method including: (a) calculating, on the basis of input data constituting a time series, difficulty in inference carried out by inputting at least one piece of the input data to a first-stage inference model among multiple-stage inference models which are configured such that use of a later-stage inference model achieves higher inference accuracy; and (b) determining, on the basis of the difficulty, whether a second- or later-stage inference model will be used for inference with use of the input data, (a) and (b) each being carried out by at least one processor.

(Supplementary Note 8)

A determination method including: (a) calculating, on the basis of training data constituting a time series, difficulty in inference carried out by inputting at least one piece of the training data to a first-stage inference model among multiple-stage inference models which are configured such that use of a later-stage inference model achieves higher inference accuracy; and (b) determining, on the basis of the difficulty, whether the training data will be used for learning of a second- or later-stage inference model, (a) and (b) each being carried out by at least one processor.

(Supplementary Note 9)

A determination program for causing a computer to function as: a first difficulty calculation means that calculates, on the basis of input data constituting a time series, difficulty in inference carried out by inputting at least one piece of the input data to a first-stage inference model among multiple-stage inference models which are configured such that use of a later-stage inference model achieves higher inference accuracy; and a first determination means that determines, on the basis of the difficulty, whether a second- or later-stage inference model will be used for inference with use of the input data.

(Supplementary Note 10)

A determination program for causing a computer to function as: a first difficulty calculation means that calculates, on the basis of training data constituting a time series, difficulty in inference carried out by inputting at least one piece of the training data to a first-stage inference model among multiple-stage inference models which are configured such that use of a later-stage inference model achieves higher inference accuracy; and a first determination means that determines, on the basis of the difficulty, whether the training data will be used for learning of a second- or later-stage inference model.

(Supplementary Note 11)

An information processing apparatus according to Supplementary note 1 or 2, further including a first inference means that carries out inference by inputting the input data to the first-stage inference model; and a second inference means that, in a case where the first determination means determines that a second-stage inference model will be used, carries out inference by inputting, to the second-stage inference model, a first feature value extracted during inference by the first inference means.

(Supplementary Note 12)

An information processing apparatus according to Supplementary note 11, further including: a second data prediction means that predicts the first feature value with use of past input data, which is a feature value extracted from a chronologically earlier frame image than a frame image from which the first feature value has been extracted; a second difficulty calculation means that calculates a prediction error of the second data prediction means as a value indicative of difficulty in inference with use of the second-stage inference model; and a second determination means that determines, on the basis of the prediction error that is calculated by the second difficulty calculation means, whether a third- or later-stage inference model will be used.

(Supplementary Note 13)

The information processing apparatus according to Supplementary note 12, wherein the second data prediction means uses a recurrent neural network model to predict the first feature value.

(Supplementary Note 14)

The information processing apparatus according to any one of Supplementary notes 1, 2, 11, 12, and 13, wherein the first determination means determines, on the basis of the difficulty, which of second- or later-stage inference models will be used for inference with use of the input data.

(Supplementary Note 15)

An information processing apparatus including at least one processor, the processor carrying out: a process for calculating, on the basis of input data constituting a time series, difficulty in inference carried out by inputting at least one piece of the input data to a first-stage inference model among multiple-stage inference models which are configured such that use of a later-stage inference model achieves higher inference accuracy; and a determination process for determining, on the basis of the difficulty, whether a second- or later-stage inference model will be used for inference with use of the input data.

Note that the information processing apparatus may further include a memory, which may store a determination program for causing the processor to carry out the process for calculating the difficulty and the determination process. The determination program may alternatively be stored in a computer-readable non-transitory tangible storage medium.

(Supplementary Note 16) An information processing apparatus including at least one processor, the processor carrying out: a process for calculating, on the basis of training data constituting a time series, difficulty in inference carried out by inputting at least one piece of the training data to a first-stage inference model among multiple-stage inference models which are configured such that use of a later-stage inference model achieves higher inference accuracy; and a determination process for determining, on the basis of the difficulty, whether the training data will be used for learning of a second- or later-stage inference model.

Note that the information processing apparatus may further include a memory, which may store a determination program for causing the processor to carry out the process for calculating the difficulty and the determination process. The determination program may alternatively be stored in a computer-readable non-transitory tangible storage medium.

### REFERENCE SIGNS LIST

1 Information processing apparatus
11 First difficulty calculation unit
12 First determination unit
2 Information processing apparatus
21 First difficulty calculation unit
22 First determination unit
3 Information processing apparatus
3021-1 First inference unit
3022-1 First data prediction unit
3023-1 First difficulty calculation unit
3021-2 Second inference unit
3022-2 Second data prediction unit
3023-2 Second difficulty calculation unit
303-1 First determination unit
303-2 Second determination unit
305 Inference model learning unit
306-1 First prediction model learning unit
307-1 First threshold updating unit

1. An information processing apparatus comprising at least one processor, the at least one processor carrying out:
a first difficulty calculation process for calculating, on the basis of input data constituting a time series, difficulty in inference carried out by inputting at least one piece of the input data to a first-stage inference model among multiple-stage inference models which are configured such that use of a later-stage inference model achieves higher inference accuracy; and
a first determination process for determining, on the basis of the difficulty, whether a second- or later-stage inference model will be used for inference with use of the input data.

2. The information processing apparatus according to claim 1, wherein
the at least one processor carries out a first data prediction process for predicting the input data that is input to the first-stage inference model, the input data being predicted from past input data that is chronologically earlier than the input data, and
in the first difficulty calculation process, the at least one processor calculates, as a value indicative of the difficulty in inference, a prediction error in the first data prediction process.

3. An information processing apparatus comprising at least one processor, the at least one processor carrying out:
a first difficulty calculation process for calculating, on the basis of training data constituting a time series, difficulty in inference carried out by inputting at least one piece of the training data to a first-stage inference model among multiple-stage inference models which are configured such that use of a later-stage inference model achieves higher inference accuracy; and
a first determination process for determining, on the basis of the difficulty, whether the training data will be used for learning of a second- or later-stage inference model.

4. The information processing apparatus according to claim 3, wherein
the multiple-stage inference models are generated on the basis of a single multilayer neural network model, and
the at least one processor carries out, in learning of the second- or later-stage inference model, an inference model learning process for also updating a weighting value of an earlier-stage inference model.

5. The information processing apparatus according to claim 3, wherein
the at least one processor carries out a first data prediction process for using a first prediction model to predict training data at a certain time point among the training data constituting the time series, the training data at the certain time point being predicted from training data at a time point chronologically earlier than the certain time point,
in the first difficulty calculation process, the at least one processor calculates, as a value indicative of difficulty in inference with use of the training data at the certain time point, a prediction error in the first data prediction process, and
the at least one processor carries out a first prediction model learning process, the first prediction model learning process being a process, carried out by learning with use of the training data constituting the time series, for updating the first prediction model so that the prediction error is decreased.

6. The information processing apparatus according to claim 3, wherein
the at least one processor determines, in the first determination process, that the training data in which the difficulty exceeds a first threshold will be used for learning of the second- or later-stage inference model, and
the at least one processor carries out a first threshold updating process for updating the first threshold on the basis of a plurality of results of inference that are obtained by inputting, to the first-stage inference model, the training data constituting the time series.

7. A determination method comprising:
(a) calculating, on the basis of input data constituting a time series, difficulty in inference carried out by inputting at least one piece of the input data to a first-stage inference model among multiple-stage inference models which are configured such that use of a later-stage inference model achieves higher inference accuracy; and
(b) determining, on the basis of the difficulty, whether a second- or later-stage inference model will be used for inference with use of the input data,
(a) and (b) each being carried out by at least one processor.

8. A computer-readable non-transitory storage medium storing therein a determination program for causing a computer to function as an information processing apparatus recited in claim 1,
the determination program causing the computer to carry out the first difficulty calculation process and the first determination process.

9. A computer-readable non-transitory storage medium storing therein a determination program for causing a computer to function as an information processing apparatus recited in claim 3,
the determination program causing the computer to carry out the first difficulty calculation process and the first determination process.
